(19) United States
(12) Patent Application Publication
(10) Pub. No.: US 2003/0195787 A1
(43) Pub. Date: Oct. 16, 2003

(54) Method of providing expert advice over a communications network

(76) Inventors: April Marie Brunk, Lake Geneva, WI (US); Deborah Lynn Beetstra, Lake Geneva, WI (US); Casey Brozek, Crystal Lake, IL (US); Michael John Childers, Chicago, IL (US)

Correspondence Address: BARNES & THORNBURG, P.O. BOX 2786, CHICAGO, IL, 60690-2786, US

(21) Appl. No.: 10/411,729

(22) Filed: Apr. 11, 2003

Related U.S. Application Data
(60) Provisional application No. 60/371,755, filed on Apr. 11, 2002.
(60) Provisional application No. 60/419,120, filed on Oct. 17, 2002.

(51) Int. Cl. G06F 17/60

(52) U.S. Cl. 705/8

(57) ABSTRACT

A system, method, and software product for distributing expert advice to an advice-seeker while on location at their selected activity. The system, method, and software product allow a user to use a variety of devices, including phones, handheld computers, and desktop computers, to quickly and cheaply connect to expert information while on location at their selected activity. Aspects of delivery of the advice may be limited depending on the particular activity. This limitation may be in the form of a time restriction or in a number of advice-seeking connections that can be made within a particular period. After or during provision of the expert advice, additional information about lessons, classes, or other learning opportunities may be provided to the advice-seeker.

### RELATED APPLICATIONS

This application claims priority under 35 USC §119(e) to of U.S. Provisional Application No. 60/371,775 filed on Apr. 11, 2002 and U.S. Provisional Application No. 60/419,120 filed Oct. 17, 2002, which are expressly incorporated by reference herein.

### BACKGROUND

For the variety of recreational activities available today, there are few resources available that allow participants to obtain immediate expert advice about such activities while on location using commonly available communication devices. In the past, one could obtain expert advice by reading books, taking classes or lessons, or by researching topics related to such activities over the Internet. However, such resources fail to provide advice to participants at the time they need it most; while they are on-location at the site of the activity.

There is therefore a need for a technology-assisted system and method for providing immediate expert advice for participants engaging in activities while they are on location.

### SUMMARY

Briefly, and in accordance with the foregoing, disclosed is a system, method, and software product for distributing expert advice. The system and method allow a user to use a variety of devices, including but not limited to phones, handheld computers, desktop computers, radio, and GPS devices to quickly and cheaply connect to expert information while on location at their selected activity. Aspects of delivery of the advice may be limited depending on the particular activity. This limitation may be in the form of a time restriction or in the number of advice-seeking connections that can be made within a particular period. After or during provision of the expert advice, additional information about lessons, classes, or other learning opportunities may be provided to the advice-seeker.

Additional features will become apparent to those skilled in the art upon consideration of the following detailed description of drawings exemplifying the best mode as presently perceived.

### BRIEF DESCRIPTION OF THE DRAWINGS

The detailed description particularly refers to the accompanying figures in which:

FIG. 1 is a diagrammatic view illustrating the general process of receiving expert advice;

FIG. 2 is a diagrammatic view of showing various communication devices;

FIG. 3 is a diagrammatic view of the types of advice available to an advice-seeker; and

FIG. 4 is a diagrammatic view of a system for providing expert advice.

### DETAILED DESCRIPTION OF THE DRAWINGS

While the present disclosure may be susceptible to embodiment in different forms, there is shown in the drawings, and herein will be described in detail, embodiments with the understanding that the present description is to be considered an exemplification of the principles of the disclosure and is not intended to limit the disclosure to the details of construction and the arrangements of components set forth in the following description or illustrated in the drawings.

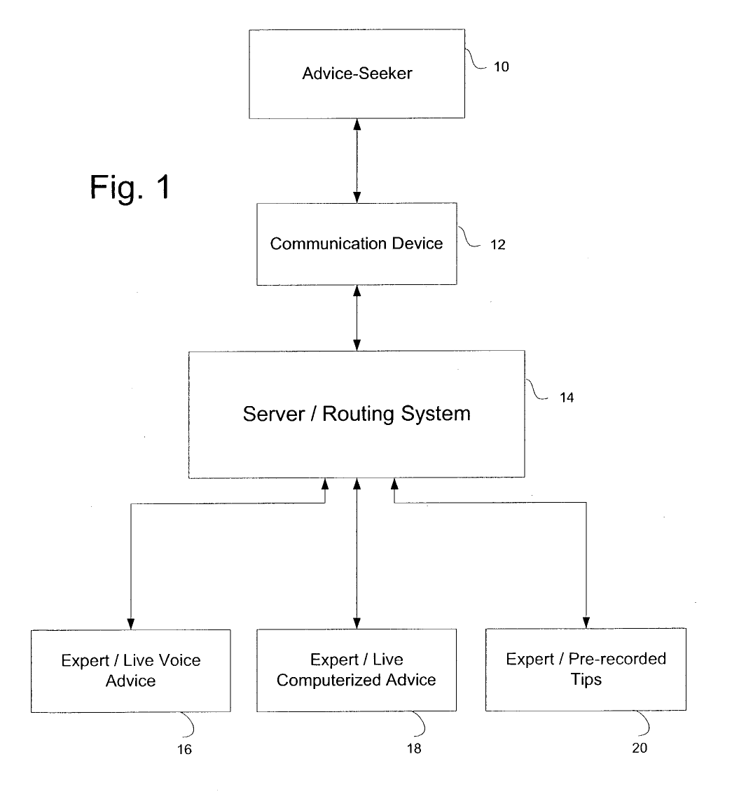

With reference to the figures, FIG. 1 provides a general overview of the method. An advice-seeker 10 on location or immediately prior to starting a selected activity, uses a communication device 12 to connect to a server or routing system 14. Depending on selections made by the advice-seeker 10, the server 14 connects the advice-seeker 10 to the appropriate type of advice. The advice may be in the form of talking live 16 with a qualified expert or in other forms as described below. The expert may be at a particular location expecting to be contacted such as at a call center or by using a dedicated line at the expert's location. The expert may also have a mobile communication device allowing the expert to be contacted anywhere.

An expert may be qualified by having certain activity-dependent credentials and by agreeing to make themselves available to answer advice-seekers' 10 questions. Qualifying credentials may include being a professional in the activity, such as, for example, being a PGA professional for golf, a retired Professional, or PGA apprentice, or be a former Olympian in an Olympic sport. For other activities, affiliation or sponsorship with a particular organization or institution may also be suitable for qualification as an expert. In certain instances, a student or qualified researcher may also be an expert. Advice may also take the form of viewing computerized advice 18. These graphics maybe of relevant locations such as, for example, a golf course for a golfer, or a ski course for a skier. Another form of advice is pre-recorded tips 20 made by the expert about various topics. Advice may also be interactive, such a for example, the advice-seeker taking a photograph of a golf ball lie or a view from a tee using a camera enabled cell phone or PDA, and sending that photo to the expert for review. Another example is an antique buyer taking a picture of an alleged antique and sending the picture to an antique expert for verification.

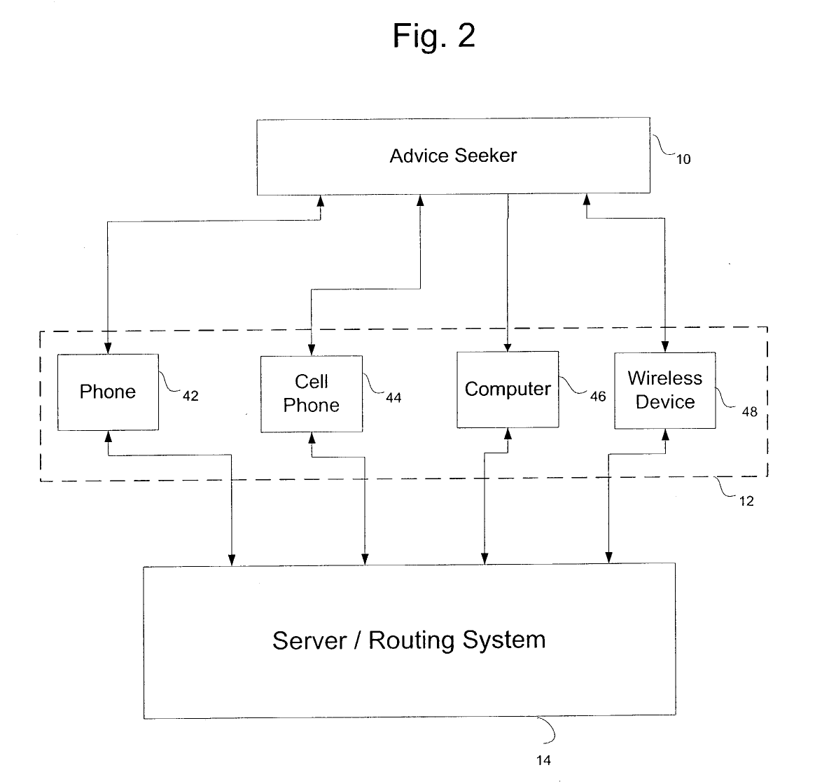

Referring now to FIG. 2, the advice-seeker 10 may use various communication devices 12 to ask for and receive the advice. Such devices may include but are not limited to a telephone 42, a cellular phone 44, a computer 46, or a wireless device 48. Other communication devices may be used such as personal digital assistants (PDAs), text messaging device, video conferencing equipment, and video streaming devices. Further, any of these communication devices may be fitted with or include a digital photo device or include a GPS interface for use when location information such a position on a golf course or ski course is relevant to the advice being sought. These devices are usable over any commonly available communications network such as the Internet, Wi-fi or wireless networks, cellular phone networks, or satellite networks.

By way of example, but not limitation, in the case of a telephone 42, the advice-seeker 10 may be required to dial the appropriate toll-free telephone number and provides their pin number, or credit card, or dial a 800 or 900 number and have their phone account charged directly. In the case of a computer 46 or wireless device 48, the advice-seeker 10 enters their login and password to retrieve expert advice from the server 14. The provider would bill the advice seeker on their account.

The central server 14 may also be configured to limit an aspect of the delivery of the advice. In one embodiment, dialing or connecting the central server 14 may activate a timer which limits the duration of a session. The duration of this time restriction maybe based on a regulation governing the flow of play for the advice-seeker's selected activity or sport. For example, in golf, it is undesirable for players to hold up others behind them by communicating with an expert for an extended period. Analogous delay is also undesirable in other sports and activities. For this reason, depending on the sport, a count down of predetermined number of minutes, such as, for example, 5 minutes, may be used to limit the duration of a session. This 5-minute time restriction, for example, is based on PGA rules. Such limitation on duration contrasts the present system and method with other 900 number services which fail to consider activity-related time concerns and instead try to keep a caller on the line as long as possible.

Calls or connections to experts maybe governed by other activity-specific rules as well. For example, where the present system is provided by a host of a particular sporting or entertainment event. For purposes of that event, the host may want only a pre-selected group of experts to be called, or perhaps wants a limitation on the number of calls for advice that could be made with a particular period, such as within a day, morning, or afternoon. It is contemplated that options for activity-specific rules are selectable either by participants or by system hosts to suit a variety of such events.

The system 14 may also be operative to provide information about additional leaning opportunities such as classes or lessons that are available in the advice-seeker's locality during or after the session with the expert. The lessons presented may be keyed into the topics discussed between the expert and the advice-seeker. For example, if the discussion was about a particular hole on a particular golf course, lessons offered by and about that course would be presented on the advice-seeker's communication device. As another example, if the expert advice was about a advice-seekers short game, lessons or classes about that topic would be presented. Determining the advice-seeker's location may be performed using GPS signals when the advice-seeker's device is so equipped or from information provided by the advice seeker.

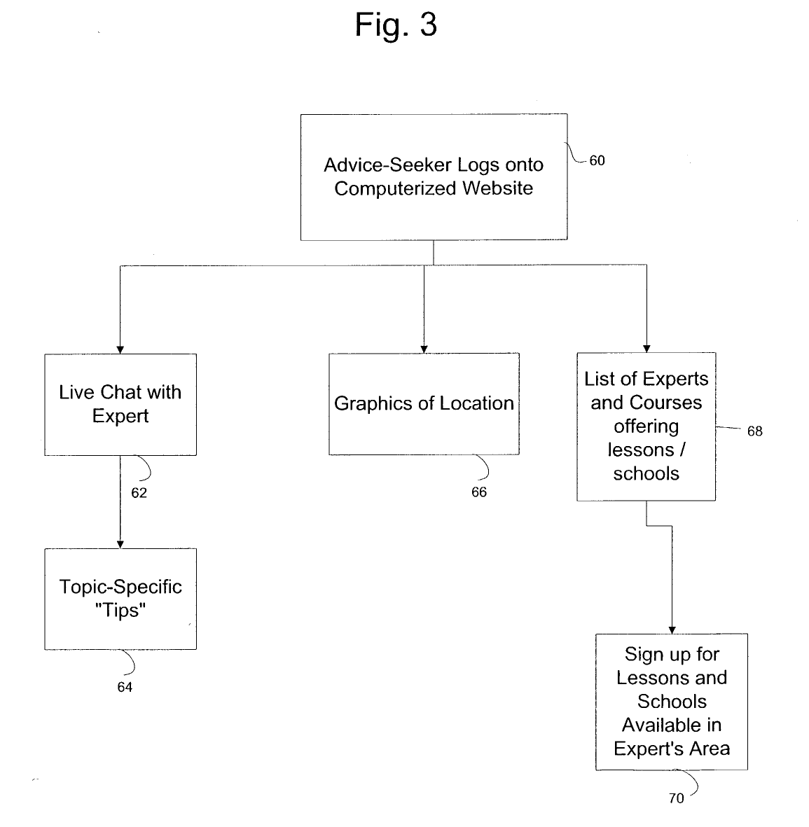

Referring now to FIG. 3, the system 14 may also provide access to expert advice via a computerized web site 60 accessible using a general purpose computer, web-enabled cell phone, PDA, or other communication device. The advice-seeker 10 logs on to the web site after which he or she has access to additional services including but not limited to live chat 62 with an expert and topic specific tips 64. The advice-seeker 10 may also view computerized graphics of topic-relevant locations 66, such as, for example, a golf course. Also, the advice-seeker 10 using the web site 60 can view a list 68 of local experts offering courses or lessons. In addition, the advice-seeker can log in to the web site 60 to sign up for the lessons or schools 70 listed on the site.

In one embodiment of the method, an advice-seeker 10 may use a pre-paid phone access card to access the system 14. An advice-seeker 10 would prepay for a quantity of minutes before using the service and be able to receive advice so long as minutes remain on the card. In the alternative, the advice-seeker 10 may subscribe to the service for a given period. A subscriber would call or login using their subscriber pin or password 84. Upon connection, the advice-seeker 10 can ask questions and receive help with a variety of topics.

The web site 60 may also provide tips from experts to the general public. Such expert-tips would be audio or audio-visual tips and information. Unlike the individualized advice given to on-location advice-seekers 10, these tips would be generalized for the public, and may be distributed as a tip-of-the day over the website 60 or via an email distribution list, or explained during weekly lessons.

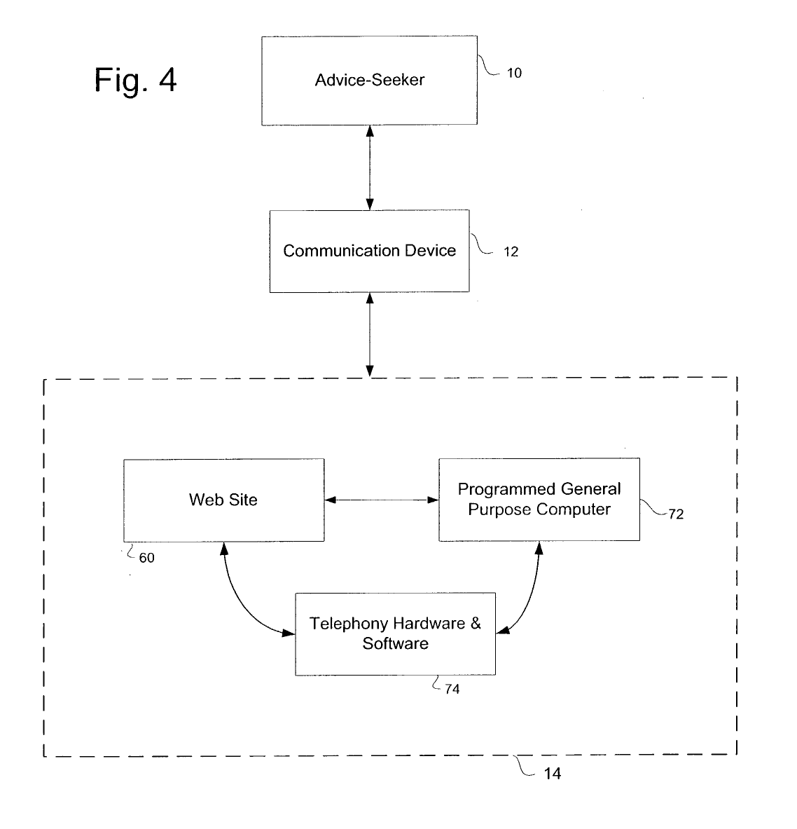

As shown in FIG. 4, one embodiment of a system 14 for retrieving and distributing the expert advice is comprised of a commercially available computer 72 and telephony-related hardware and software combination 74 of known construction. The system 14 communicates with advice seekers 10 calling in by phone using the general purpose computer 72 programmed with, for example, call center PBX-based or Centrex based routing. PBX based systems convert analog phone signals into digital phone signals which can be manipulated in manners such as, for example, routing, recording, or logging, and can be delivered over conventional phone lines or over Voice-over-IP. Voice-over-IP software complying with the industry known H.323 standard allows for routing landline calls over the Internet or analogous communications network, or over an internal intranet maintained by a system host. The system 14 routes to appropriate expert advice in a manner similar to phone systems today routing to a particular extension on an automated call answer system. One example of call software capable of running the system on a general purpose computer is TeleVantage Server 4.0 from Artisoft, Inc. The system is configured using such software to record call times and selected call option for billing purposes.

Certain limited routing features for this system 14 may also be facilitated by telephony service providers. Local and regional telephone companies such as AT&T or MCI offer pay per call or pay per minute business services which when configured to provide the connectivity described above, may be used in connection with the disclosed routing system 14. Providers of toll or 900 number services, such Custom900.com may also be used to provide the routing services.

For advice-seekers 10 communicating with the system 14 over the Internet or other communications network, a web site 60, may be constructed using a general purpose computer 72, programmed with commercially available database and web server software. Many off-the-shelf authoring packages may be used to program the functionality of the method described above. Examples of software for constructing, web hosting, retrieving, and delivering stored expert advice include SQL Server from Microsoft Corporation, Cold Fusion from Macromedia, Inc., and FrontPage from Microsoft Corporation.

In use, a routing system is used to provide the functions described above. The routing system includes a processor with system memory operated by one or more program modules. The term “module” referenced in this disclosure is meant to broadly cover various types of software code including but not limited to routines, functions, objects, libraries, classes, members, packages, procedures, or lines of code together performing similar functionality to these types of coding. A storage device, such as, for example, a floppy drive, hard drive, tape drive, a CDR, or a CDRW, is also included for storing and retrieving software code, data, billing information, calls logs, advice-seeker information, and information about participating experts. A communications interface is provided to facilitate communication with communication devices used by the user and/or the expert. The communications interface may be a network card, a serial port, parallel port, firewire port, or wireless network card and be connected to a variety of voice, data, IP, optical, or wireless networks. Also, data may be stored remotely, such as on a data server, and may likewise be accessed using the communications interface.

A general purpose computer or similar device may also be programmed to perform the functions described above using a software program product written with software modules for performing the operating, connection, and communication functions of the system. The software program product may be in the form of a computer readable medium or retrieved electronically such as by download from the Internet or using a web-based ASP. Computer readable media include floppy disks, CDs, or DVDs.

Examples of advice seekers 10 using the system 14 include, but are not limited to, the following. An advice seeker 10 is an amateur skier on a Nastar course. The skier runs the course, finishes, but realizes his time for the bottom half of the course is less than desirable and is unsure of the cause. The skier then uses a cell phone 44 to call the system 14 and is immediately connected to an expert such as a Nastar medalist, ex-Olympian, or certified ski racing coach who provides advice on corrections that should be made in subsequent runs.

Another example of an advice seeker is a person involved in a home improvement project, who is at location (possibly a store) making a product decision or a person working on a home, for example, tiling a bathroom needing instructions.

Another example of advice seeker 10 may be a person cooking for a dinner party. The system 14 would similarly provide immediate access to an expert, such as, a licensed chef or award winning chef, or a qualified person/chef in a culinary school.

The following are additional examples of various categories of activities and their associated experts. Categories are provided for illustrative purposes only. Experts or fields of expertise may be in one or more of any of such categories.

In the field of “Sports and Recreation,” experts may include but are not limited to licensed professionals, retired professionals, members of accredited organizations, and award winning athletes or athletes that have national titles.

Sports particularly well suited for the above system, although not an exhaustively listed, may include golf, downhill skiing, ski racing, cross-country skiing, tennis, baseball, basketball, hockey, football, soccer, biking, game fishing, fly fishing, hunting, body building, backing packing, and camping.

Experts in the field of “Arts & Interests” may include but are not limited to the experts listed above in addition to individuals who have received awards or national titles in their fields. Activities may include but are not limited to cooking, antiquing, collecting, sewing, painting, sculpting or other composing of art, photography, study of literature, architecture, gardening, film, music, hobbies and crafts, interior design, travel, jewelry design, home renovation, the study of history, astrology/horoscopes, home improvement including renovations, new constructions, plumbing, electrical design, landscaping, and interior design.

Experts in the field of “Health and Safety” may include but are not limited to the experts listed above. Areas of expertise may include, such as, for example, diet and nutrition, family counseling, parenting, medical concerns for children, adults or pets, geriatrics, relationships, dating, sexuality, alternative medicine, herbology, aromatherapy, self-help, academics, pharmaceutical questions, accident prevention, crime prevention, terrorist attack preparedness such as child safety proofing, health and beauty, fashion consulting, cosmetology, hair, counseling, life strategy.

Finally, in the area of “Life, Money & Careers,” experts may include but are not limited to those mentioned above with expertise in areas such as, for example, accounting, business, tax, computers, legal questions, insurance, investment, stocks, mortgages, real estate, estate planning, asset protection, imports and exports, foreign affairs, scholarships and grants.

Other categories of experts and advice may also be served by the system 14 method, and software product disclosed above.

While a preferred embodiment of the disclosure is shown and described, it is envisioned that those skilled in the art may devise various modifications and equivalents without departing from the spirit and scope of the invention as recited in the following claims.

1. A method for providing expert activity-specific advice to an advice-seeker over a communications network, the method comprising the steps of:
providing a routing system, the routing system configured to be able to communicative with a communication device usable by the advice-seeker while at a location of a selected activity;
connecting the advice-seeker to an expert via the communication device and the routing system; and
having the expert provide advice to the advice-seeker about the selected activity.

2. The method of claim 1, wherein the routing system is configured to limit an aspect of the delivery of the advice depending on the selected activity.

3. The method of claim 2, wherein the aspect of the delivery of the advice is a time restriction.

4. The method of claim 3, wherein the time restriction is based on a regulation of a selected sport.

5. The method of claim 2, wherein the aspect of the delivery of the advice is a number of connections within a particular period.

6. The method of claim 2, wherein the selected activity is golf and wherein the expert is a PGA professional.

7. The method of claim 6, wherein the aspect of the delivery of the advice is a 5-minute time restriction.

8. The method of claim 1, further comprising the step of having the routing system provide information about learning opportunities related to the advice in the advice-seeker's locality.

9. A computerized system for providing expert activity-specific advice to an advice-seeker over a communications network, the system comprising a storage device, memory, a program module, a communications interface, and a processor responsive to a plurality of instructions from the program module, being operative to:
communicate with a communication device usable by the advice-seeker while at a location of a selected activity;
connect the advice-seeker to an expert; and
facilitate communication between the expert and the advice-seeker about the selected activity.

10. The system of claim 9, wherein the system is further operative to limit an aspect of the delivery of the advice depending on the selected activity.

11. The system of claim 10, wherein the aspect of the delivery of the advice is a time restriction.

12. The system of claim 11, wherein the time restriction is based on a regulation of a selected sport.

13. The system of claim 10, wherein the aspect of the delivery of the advice is a number of connections within a particular period.

14. The system of claim 10, wherein the selected activity is golf and wherein the expert is a PGA professional.

15. The system of claim 14, wherein the aspect of the delivery of the advice is a 5-minute time restriction.

16. The system of claim 9, wherein the system is further operative to provide information about learning opportunities related to the advice in the advice-seeker's locality.

17. A software program product, the software program product comprising:
a module for operating a routing system to communicate with a communication device usable by the advice-seeker while at a location of a selected activity;
a module for connecting the advice-seeker to an expert; and
a module for facilitating communication between the expert and the advice-seeker about the activity.

18. The software program product of claim 17, further comprising a module for limiting an aspect of the delivery of the advice depending on the selected activity.

19. The software program product of claim 18, wherein the aspect of the delivery of the advice is a time restriction.

20. The software program product of claim 19, wherein the time period is based on a regulation of a selected sport.

21. The software program product of claim 18, wherein the aspect of the delivery of the advice is a number of connections within a particular period.

22. The software program product of claim 18, wherein the selected activity is golf and wherein the expert is a PGA professional.

23. The software program product of claim 22, wherein the aspect of the delivery of the advice is a 5-minute time restriction.

24. The software program product of claim 17, further comprising a module for providing information about learning opportunities related to the advice in the advice-seeker's locality.
